(19) United States
(12) Patent Application Publication
(10) Pub. No.: US 2004/0052508 A1
(43) Pub. Date: Mar. 18, 2004

(54) Method and apparatus for recording coded audiovisual data

(75) Inventor: Koji Iwashita, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/650,739

(22) Filed: Aug. 29, 2003

(30) Foreign Application Priority Data
Sep. 13, 2002 (JP) 2002-268489

(51) Int. Cl. H04N 5/781; H04N 5/85; H04N 5/90; H04N 5/91

(52) U.S. Cl. 386/125

(57) ABSTRACT

When coding and recording video/audio information on a disk, a coding rate is set with reference to a data size that is an integral multiple of the least common multiple of a packet data size and a sector size of the disk.

### BACKGROUND OF THE INVENTION

1. Field of the Invention

The present invention relates to a method and an apparatus for recording MPEG-2 TS data on a disk form recording medium such as an optical disk.

2. Related Background Art

Currently, in Japan and the Western countries, as a data system for transmitting information-compressed video and audio signals in satellite digital broadcasting, terrestrial digital broadcasting, and the like, MPEG-2 transport stream (hereinafter referred to as the “MPEG-2 TS”) stipulated in ISO/IEC13818 are applied thereto.

The MPEG-2 TS are generated by time-division multiplexing information data corresponding to each of video signals and audio signals of broadcast programs in units called “MPEG-2 TS packets” having a 188-byte fixed length. If it is possible to store and manage such MPEG-2 TS corresponding to broadcast programs on a randomly accessible disk form recording medium, such as a hard disk or an optical disk, on a reception side as a written record or a data file while maintaining their information-compressed digital signal state on a transmission side, it becomes possible to repeatedly view AV programs of high quality at any time, to perform random-access reproduction with quick response, and to perform program editing with high flexibility, while completely preventing degradation in image quality and sound quality.

In recent years, however, it is started to handle data in the form of MPEG-2 TS in devices, such as a disk cam coder, that record and reproduce video/audio signals for personal use in addition to in the broadcasting field.

On the other hand, disk access to a randomly accessible disk form recording medium, such as an existing hard disk or optical disk, is usually performed in units of logical blocks (2048 bytes, for instance) called “sectors” based on a file system such as FAT (File Allocation Table) or UDF (Universal Disk Format).

In specifications defined to manage data existing on a disk using such a file system now in use, the followings are stipulated.

1. The recording/writing of data must be necessarily started from the top of a sector.

2. Data must not be interrupted at a midpoint in a sector other than a sector containing an end of a data file.

3. Different data files must not exist in the same sector area.

Even in the case where MPEG-2 TS data is recorded or reproduced by a recording and reproducing apparatus that uses a disk form recording medium adopting the above-mentioned file system now in use, it is required to conform these stipulations.

FIG. 3 shows a structure of MPEG-2 TS data recorded on a disk. In this drawing, the MPEG-2 TS data is recorded in sectors each having a 2048-byte size as multiple successive packets each having a 188-byte data length, with the data being written into the entire area of each sector other than the last sector.

In order to manage the data recorded as a file in this manner, file name information that is arbitrarily definable by a user, a sector position on the disk from which the contents of the file starts, and a data size of the file are associated with each other using file system information shown in Table 1.

With this file system information, it is possible for a user to perform disk access, such as reproduction or editing, merely by specifying a file name without concern for the position of the data on the disk.

However, packets constituting MPEG-2 TS defined by the MPEG standard each have a 188-byte fixed length. Therefore, when a user instructs a recording and reproducing apparatus for a disk form recording medium adopting the file system described above to perform an edit process in which MPEG-2 TS data recorded on a disk is divided or combined, it is unavoidable to perform an alignment adjustment process because sector boundaries and TS packet boundaries do not coincide with each other.

An example of a dividing process performed by a conventional disk recording and reproducing apparatus that uses the file system shown in FIG. 3 will be described with reference to FIGS. 5 to 8 and 9.

FIGS. 5 to 8 show how a data structure of MPEG-2 TS packet data recorded on a disk changes through a dividing process. Also, in FIG. 9, a dividing process procedure is shown as a flowchart.

In FIG. 5, first, a user requests to divide a data file “FILE0000” recorded on a disk form recording medium at an MPEG-2 TS packet data boundary position “188*n_{DIV}” (step 1). Following this, a new file name “FILE0001” of data from the top of the file by the divide position is entered into file system information, and position and size information giving the start sector position “#N” of the original file “FILE0000” and a file size “188*n_{DIV}” up to the divide position is entered into the file system information (step 2).

Next, as shown in FIG. 6, a data size “L” of data from the divide position “188*n_{DIV}” until the next succeeding sector “N+1” is calculated based on Equation (1) given below (step 3). Following this, an additional number of dummy TS packets “n_{dummy}” for establishing alignment between the packet boundary and the sector boundary is calculated from this “L” so that Equation (2) given below becomes true (step 4).

L=2048−(188*n_{DIV}mod2048)) (1)

(L+188*n_{dummy})mod2048=0 (2)

Here, the operator “mod” in “AmodB” expresses the remainder of division of A by B.

A non-written sector “X” existing on the disk is searched with reference to “n_{dummy}”, and dummy TS packets of “188*n_{dummy} bytes” are written from the top of the sector “X” (step 5).

Next, as shown in FIG. 7, the number “#NDIV” of the sector containing the divide position “188*n_{DIV}”of the MPEG-2 TS data that is the division target is calculated based on Equation (3) given below (step 6).

#N_{DIV}=#N+188×n_{DIV}/2048 (3)

The entire data in the sector having the sector number “#N_{DIV}” calculated based on Equation (3) is written into a buffer such as a random access memory (data size of one sector is set at 2048 bytes in this “Related Background Art” section and the following “embodiment of the present invention”), and data of “2048-L bytes” from the read start position on the memory is replaced with dummy TS packet information (step 7).

Following this, as shown in FIG. 8, the number “#Xend” of a sector containing the end of the recorded “188×n_{dummy} bytes” is calculated from the number “#X” of the sector, from which the recording of the dummy TS packet on the disk is started, based on Equation (4) given below (step 8).

#Xend=#X+(188×n_{dummy})/2048 (4)

The sector data read onto the memory in step 7 is overwritten on 2048 bytes in the sector “#Xend” (step 9).

After the above operations are performed, position and size information giving the access start sector number “#X”, the access data size “188×n_{dummy}+L” bytes, the access start sector number “#N_{DIV}+1”, and the access data size “188*n₁₋₁₈₈*n_{DIV}-L” bytes are entered into the file system as an after-divide file “FILE0002”, and this MPEG-2 TS packet data dividing process is ended (step 10).

When a user performs editing, such as division, on MPEG-2 TS packet data like this, the editing is performed in units of 188-byte TS packets. However, in order to concurrently make it possible to access edited data through the file system, it is required to establish alignment so that a data edit position meets a sector boundary.

For this purpose, the alignment described above has conventionally been established by adding dummy data that is NULL data to the edited data. With this method, however, it is required to secure a dummy data area by searching a vacant area each time editing is performed. As a result, there arises a problem that the throughput of the edit process is lowered and the ease-of-use of an apparatus is impaired.

### SUMMARY OF THE INVENTION

The present invention has been made in order to solve the problem described above, and provides a method and an apparatus for recording video packet data on a recording medium having plural sectors, where a coding rate for video packet data is set with reference to a data size that is an integral multiple of the least common multiple of a packet data size and a sector size of the medium.

With this structure, it becomes unnecessary to establish alignment between sector area boundaries and packet data boundaries to thereby have these boundaries coincide with each other each time editing is performed. As a result, there is eliminated the necessity to search a vacant area and to record a dummy TS packet, and therefore it becomes possible to easily and speedily perform an edit process such as division, combination, partial deletion, or insertion.

Also, when the packet data size of video data (MPEG-2 TS data) is set at 188 bytes, the sector size is fixed at 2048 bytes, the size of one GOP is set at an integral multiple of 96256 (94 KB) that is the least common multiple of 188 bytes and 2048 bytes, and a coding rate is set with reference to this GOP size, each GOP is formed by data in sectors whose number is an integer. As a result, an edit process performed in units of GOPs becomes easy and speedy.

Further, the coding rate is set as variable, hence it becomes possible to have both preservation of image quality and easiness of editing.

### BRIEF DESCRIPTION OF THE DRAWINGS

Preferred embodiment(s) of the present invention will be described in detail based on the following figures, wherein:

FIG. 1 is a correspondence table showing correspondences between GOP sizes and coding rates according to an embodiment of the present invention;

FIG. 2 is a block diagram of a video signal coding apparatus that implements a coding rate control method of the present invention;

FIG. 3 shows a structure of MPEG-2 data recorded on a disk form recording medium;

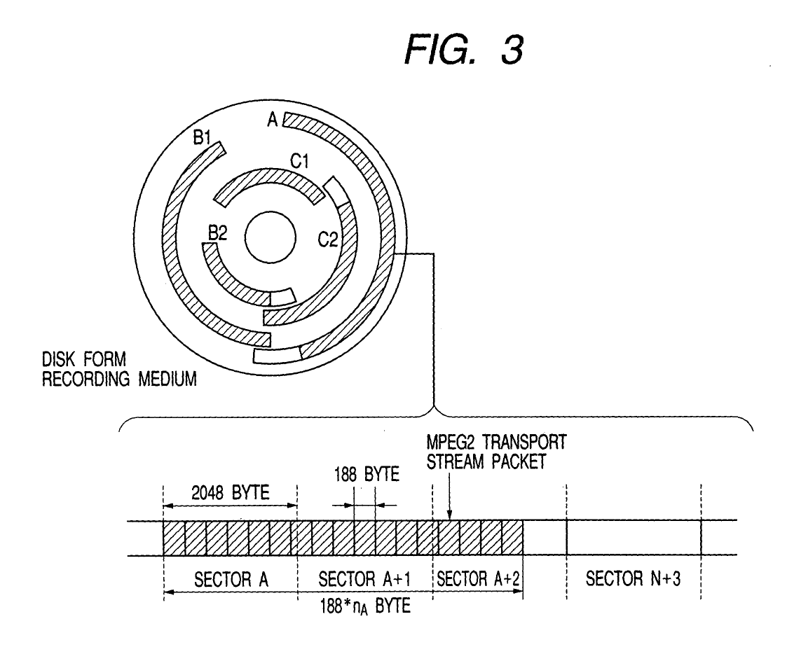

FIG. 4 shows an example of frame images constituting a GOP;

FIG. 5 shows a conventional MPEG-2 data file dividing process;

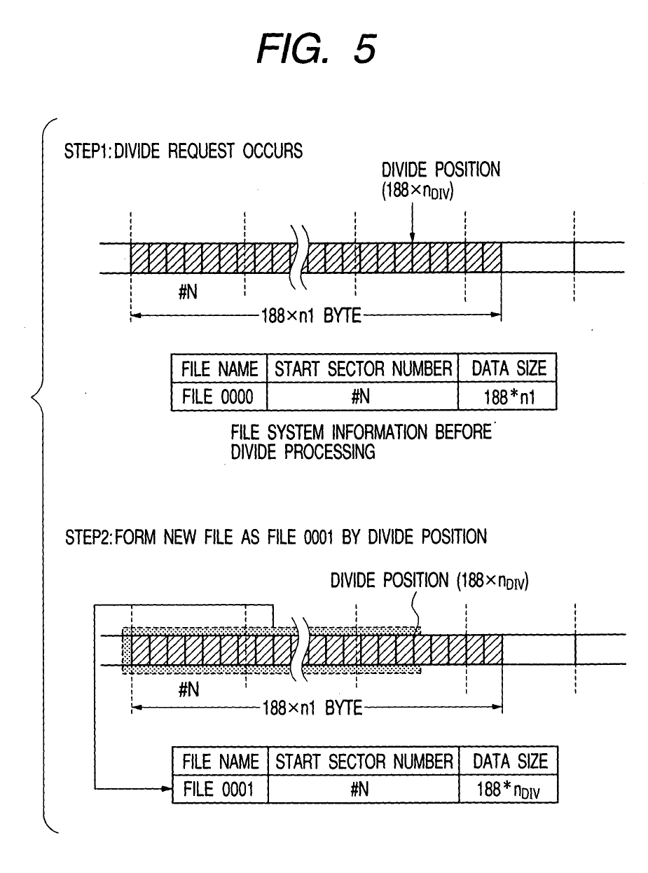

FIG. 6 also shows the conventional MPEG-2 data file dividing process;

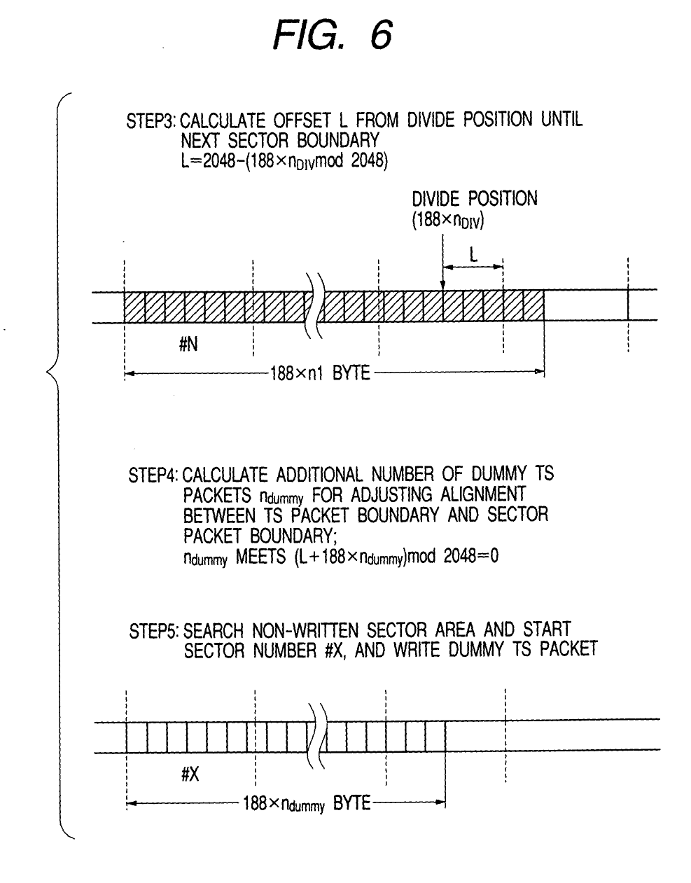

FIG. 7 also shows the conventional MPEG-2 data file dividing process;

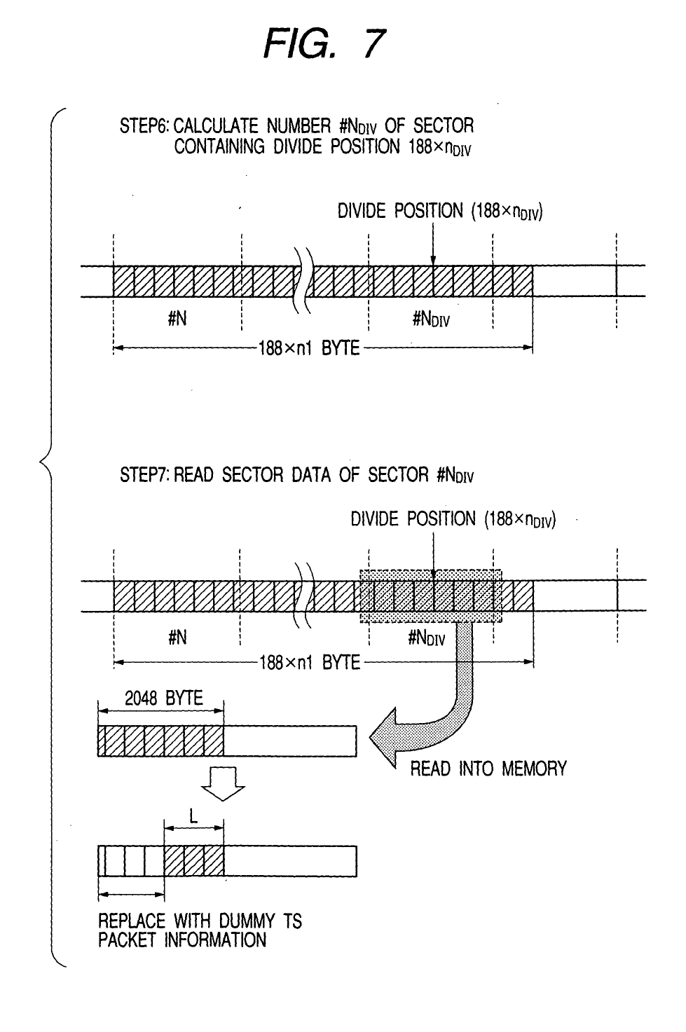

FIG. 8 also shows the conventional MPEG-2 data file dividing process;

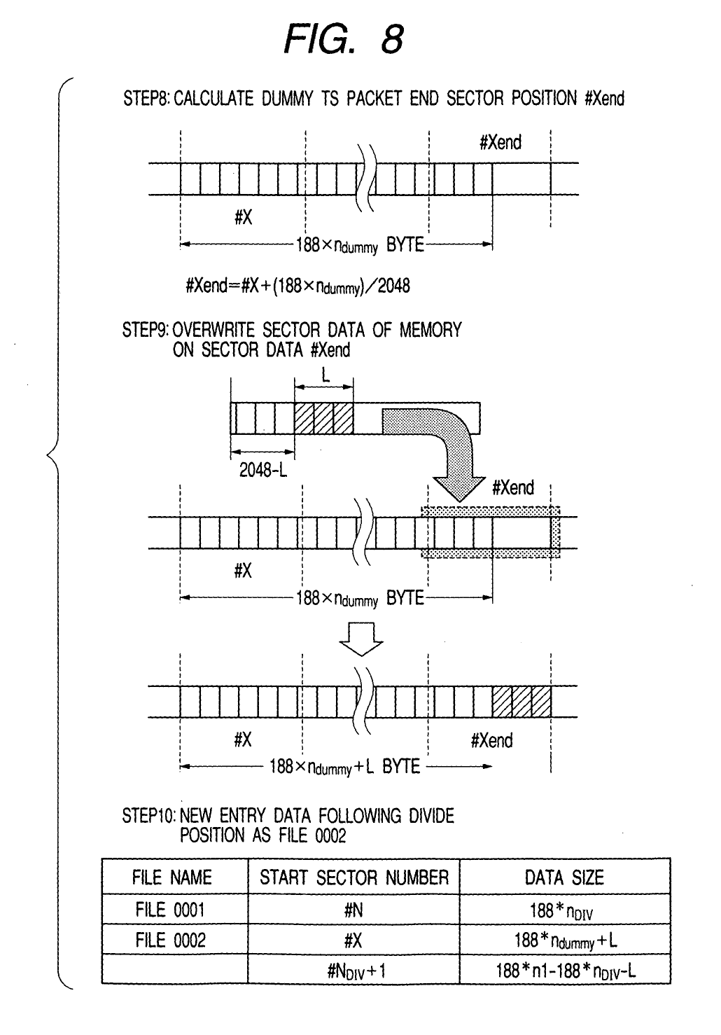

FIG. 9 is a flowchart of the conventional MPEG-2 data file dividing process;

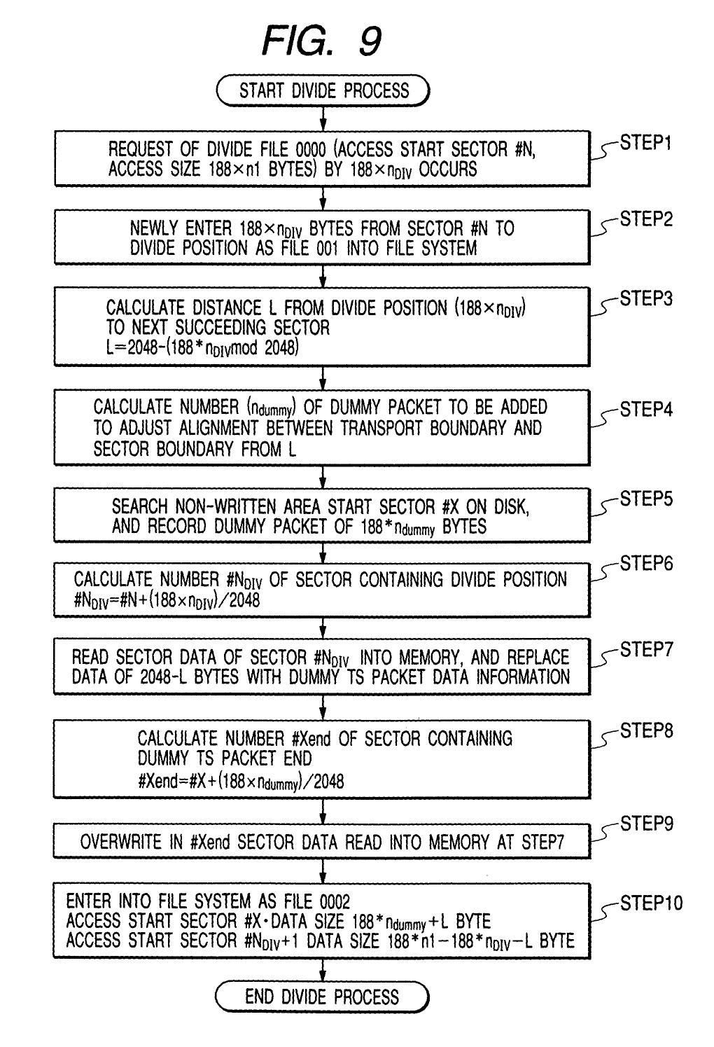

FIG. 10 shows an MPEG-2 data file dividing process according to the present invention; and

FIG. 11 is a flowchart of the MPEG-2 data file dividing process according to the present invention.

### DETAILED DESCRIPTION OF THE PREFERRED EMBODIMENTS

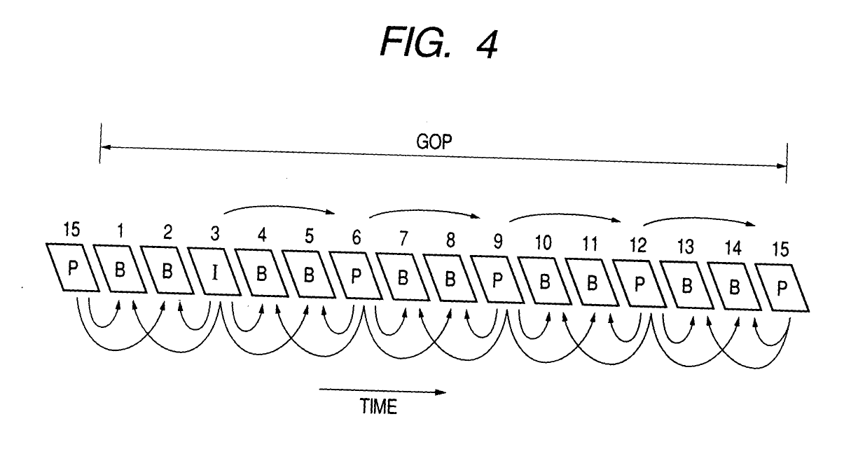

First, prior to description of an embodiment of the present invention, the outline of an information unit called “GOP (Group OF Picture)” of compressed information signal obtained through compression-coding in the MPEG-2 system will be described with reference to FIG. 4. In FIG. 4, an example of multiple frame images constituting one GOP is shown, with the GOP being formed of 15 frame images (corresponding to a reproduction time of around 0.5 seconds). Note that in the MPEG-2 system, the number of frame images contained in one GOP is not specifically limited and therefore may be set at a number other than 15 in actual cases.

Among these 15 frame images, each frame image given the reference symbol “I” is a frame image that is called “I picture (Intra-coded picture) and is capable of reproducing a complete frame image by itself.

Also, each frame image given the reference symbol “P” is a predictive image that is called “P picture (Predictive-coded picture) and is generated to decode a difference with a predictive image compensated and reproduced, based on an already decoded I picture or another P picture.

Further, each frame image given the reference symbol “B” is a predictive image that is called “B picture (Bidirectionally predictive-coded picture) and is reproduced using not only a chronologically preceding I picture or P picture but also a chronologically succeeding I picture or P picture for prediction. In FIG. 4, prediction relationships (interpolation relationships) among respective pictures are indicated by arrows.

As described above, an edit process (combination, division) of MPEG-2 data is performed in units of GOP with consideration given to decoding.

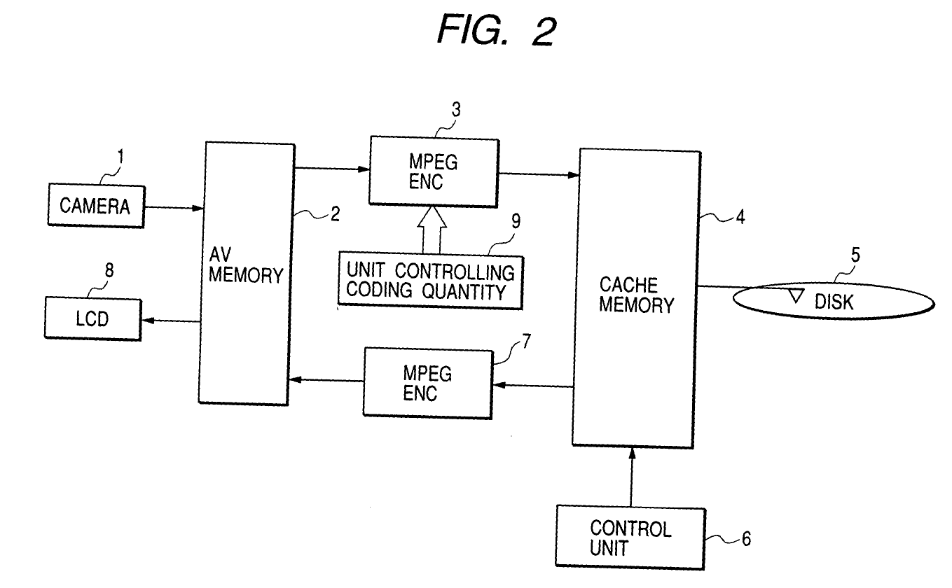

Next, a concrete structure of the present invention will be described. FIG. 2 is a block diagram of a audiovisual signal coding apparatus. An input video image taken by a camera 1 is temporarily stored in an AV memory 2 and is coded into MPEG-2 TS packet data at a predetermined coding rate in an MPEG encoder 3. The coded data is stored in a cache memory 4 and then is recorded on a disk 5. The recording onto and reproduction from the disk 5 are controlled by a control unit 6. After being read from the disk, the coded data is stored in the cache memory 4, is decoded by an MPEG decoder 7, and is displayed on a display apparatus, such as an LCD 8, through the AV memory 2.

In the present invention, the least common multiple of 188 bytes that is the packet data size of the MPEG-2 TS packet data and 2048 bytes that is the sector size of the disk is calculated, and each GOP is set so as to have a size that is an integral multiple of the least common multiple. Then, a unit controlling coding quantity 9 controls the coding rate of the MPEG encoder 3 so that each GOP has the specified GOP size. As a result, one GOP is formed by MPEG-2 TS packets, whose number is an integer, and is recorded in sectors whose number is an integer. As a result, GOP boundaries necessarily coincide with sector boundaries.

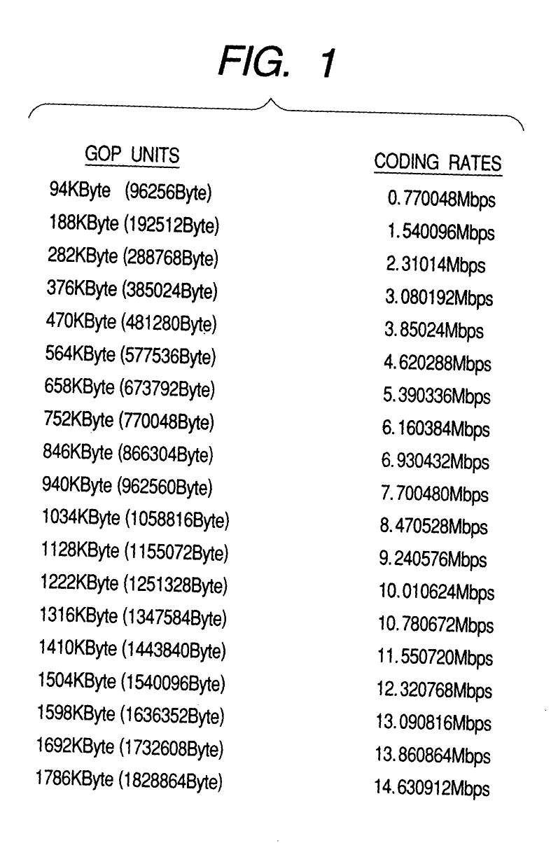

FIG. 1 is a correspondence table showing correspondences between GOP sizes and coding quantities in the case where MPEG-2 TS packet data having a fixed packet data size of 188 bytes is recorded on a disk adopting a file system having a fixed sector size of 2048 bytes (in the case of UDF). As can be seen from this correspondence table, if the size of one GOP is set at 385024 (376 KB) obtained by multiplying 96256 (94 KB) that is the least common multiple of 188 bytes and 2048 bytes by four, for instance, it is sufficient that the coding is performed at 3.080192 Mbps.

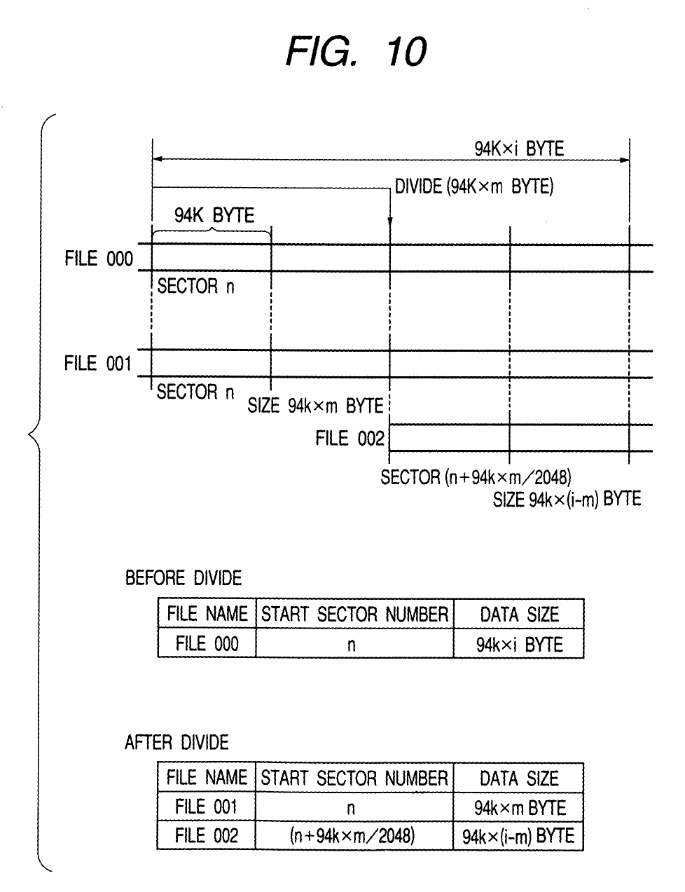

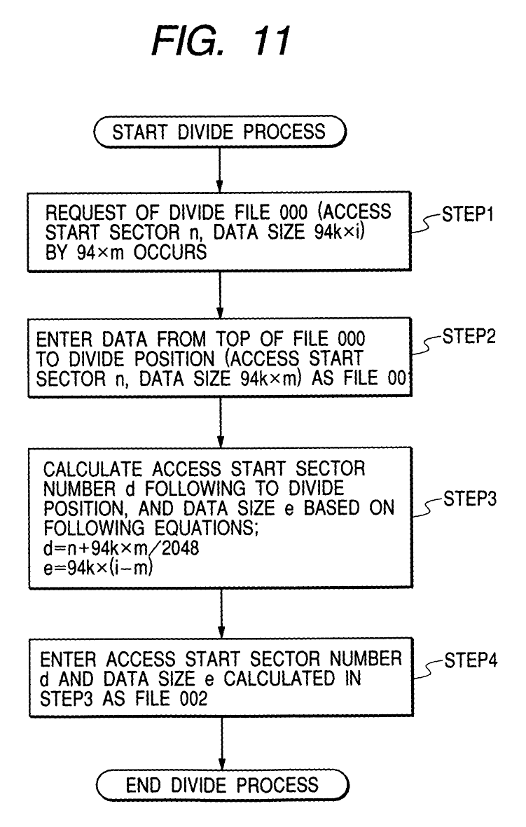

Next, a case where a dividing process is performed on MPEG-2 TS packet data that has been coded and recorded on the disk in the manner described above will be described. FIG. 10 shows how the data structure of transport data recorded on the disk changes, and FIG. 11 is a flowchart showing a dividing process procedure.

In FIG. 10, first, a user requests to divide a data file “FILE000” (access start sector “n”, data size “94k×i”) recorded on a disk form recording medium at an MPEG-2 TS packet data boundary position “94k×m” (step 1). Following this, a new file name “FILE001” of data from the top of the file by the divide position is entered into file system information, and position and size information giving the start sector position “n” of the original file FILE000” and a file size “94k×m” up to the divide position is entered into the file system information step 2).

Following this, a start sector number “d” of data following the divide position “94kxm” is calculated from the following equation.

d=(n+94k×m/2048)

Next, a data size “e” of the data following the divide position is calculated from the following equation (step 3).

e=94k×(i−m)

Then, position and size information giving the access start sector “d” and the access data size “94k×(i−m) bytes” obtained in the manner described above is entered into a file system as an after-divide file “FILE002”, and this MPEG-2 TS data dividing process is ended (step 4).

It should be noted here that it is not required to fix the coding rate throughout coding of video data and it is possible to arbitrarily change the coding rate midway through the coding in accordance with the contents of video data.

Even when the former half of video data is coded at 4.620288 Mbps and the latter half thereof is coded at 7.70048 Mbps, for instance, the size of each GOP becomes an integral multiple of 94 KByte, as can be seen from FIG. 1. As a result, even if the coding rate is arbitrarily changed to any one of the values shown in FIG. 1 midway through coding, the number of sectors constituting each GOP becomes an integer, which facilitates editing.

TABLE 1

| | Start sector | Access | Creation date |
|---|---|---|---|
| File Name | number | size | and time, etc. |
| FILE A | A | 188*n_{A} | yyyymmdd |
| FILE B | B1 | (188*n_{B}-X) | yyyymmdd |
| | B2 | X | |
| FILE C | C1 | (188*n_{c}-Y) | yyyymmdd |
| | C2 | Y | . . . |
| . . . | . . . | . . . | . . . |

As described above, with the structure of the present invention, the coding rate is set with reference to a data size that is an integral multiple of the least common multiple of the packet data size and the sector size of the medium, so that the sector area boundaries and the packet data boundaries coincide with each other. Therefore, it becomes unnecessary to establish alignment between these boundaries each time editing is performed, which eliminates the necessity to search a vacant area and to record a dummy TS packet. As a result, it is expected that speedup is achieved due to reduction in the number of accesses to the file system managing data addresses on the disk and reduction in the number of computations by a CPU. Also, it becomes possible to easily and speedily perform an edit process such as division, combination, partial deletion, or insertion.

Further, the data size, with reference to which the coding rate is determined, is made variable, so that it becomes possible to increase the coding rate by increasing the data size and to concurrently realize recording and reproduction of high-quality video signals.

What is claimed is:

1. A method of recording audiovisual data including a plurality of pieces of packet data on a recording medium having a plurality of sectors, comprising:
setting a coding rate, at which an inputted audio and video signal is converted into packet data, with reference to a data size that is an integral multiple of a least common multiple of a packet data size and a sector size of the recording medium; and
recording coded data on the recording medium.

2. A method of recording audiovisual data according to claim 1,
wherein the audio and video data is MPEG-2 TS data having the packet data size of 188 KB,
wherein the sector size is fixed at 2048 bytes,
wherein the size of one GOP is set at an integral multiple of 96256 (94 KB) that is the least common multiple of 188 bytes and 2048 bytes, and
wherein the coding rate is set with reference to the GOP size.

3. A method of recording audiovisual data according to claim 1, wherein the coding rate is set as variable.

4. An apparatus for recording audiovisual data including a plurality of pieces of packet data on a recording medium having a plurality of sectors, comprising:
a coding unit for setting a coding rate at which an inputted video signals is converted into packet data, with reference to a data size that is an integral multiple of a least common multiple of a packet data size and a sector size of the recording medium; and
a control unit for recording coded data on the recording medium.
